(19) United States
(12) Patent Application Publication
(10) Pub. No.: US 2023/0234815 A1
(43) Pub. Date: Jul. 27, 2023

(54) WINCH WITH HELICAL GROOVE AND LINE GUIDE

(71) Applicant: Hall Labs LLC, (US)

(72) Inventors: David R. Hall, Provo, UT (US); Jerome Miles, Spanish Fork, UT (US)

(73) Assignee: Hall Labs LLC

(21) Appl. No.: 18/060,534

(22) Filed: Nov. 30, 2022

Related U.S. Application Data
(60) Provisional application No. 63/284,356, filed on Nov. 30, 2021.
(60) Provisional application No. 63/373,327, filed on Aug. 23, 2022.
(60) Provisional application No. 63/373,324, filed on Aug. 23, 2022.

(51) Int. Cl. B66D 1/30; B66D 1/38

(52) U.S. Cl. CPC B66D 1/30; B66D 1/38; B66D 2700/0191; B66D 2700/0125

(57) ABSTRACT

A winch with a spool having an axis of rotation and a helical groove formed thereon and a line around the spool in the helical groove. The winch also includes a motor configured to rotate the spool in a first direction to wind the line on the spool and a second direction to unwind the line from the spool. The helical groove includes a line cradle shaped to carry the line with a portion of the line protruding from the helical groove, and a channel extending below the line cradle. A portion of the channel is not occupied by the line. The winch also includes a line guide adjacent to the spool and configured to move axially along the spool. The line guide includes a tab that engages the channel to cause the line guide to move axially along the spool to wind or unwind the line.

### CROSS-REFERENCE TO RELATED PATENT APPLICATIONS

This application claims priority to U.S. Provisional Patent Application No. 63/284,356 entitled “Winch with Helical Groove and Line Guide,” filed on Nov. 30, 2021. This application also claims priority to U.S. Provisional Patent Application No. 63/373,327, entitled “Winch with Supporting Tie Rod,” filed on Aug. 23, 2022. This application also claims priority to U.S. Provisional Patent Application No. 63/373,324, entitled “Raisable Grow System,” filed on Aug. 23, 2022. The entire disclosures of these three prior applications are incorporated herein by reference.

### TECHNICAL FIELD

The present disclosure is directed to the field of lifters, hoists and winches.

### BACKGROUND

Lifters, hoists and winches are used extensively to lift, lower, or pull loads of various kinds. Such devices typically include a line, such as a cable or chain, wrapped around a spool. To lift, lower, or pull a load, the spool may be manually rotated or driven with a motor, such as an electrical, hydraulic, or pneumatic motor. When rotation is not desired, a braking mechanism may be used to prevent the spool from turning. This may maintain tension in the line, keep a load suspended, or prevent the release or unspooling of the line. To keep the line from bunching on the spool, some hoists or winches may include guides or other mechanisms to evenly wind the line around the spool.

Although a wide variety of lifters, hoists and winches are available, many have shortcomings that prevent or discourage their use in various applications. For example, some hoists or winches are bulky or cumbersome, which may prevent their use in applications where greater compactness is required or desired. Other hoists and winches may be economically infeasible for use in applications such as consumer or residential applications due to their complexity or expense.

Maintaining a flexible line in an orderly way and preventing excessive slack, bunching, and misalignment ensures proper winch operation. Without proper spacing, tension, and alignment the flexible line can become jammed or wear unevenly leading to material degradation or even failure. There is a need in the art for a winch that can maintain a flexible line in an efficient way to ensure a long effective life of the device.

### SUMMARY

Embodiments of the present disclosure are directed to a winch including a spool having an axis of rotation and a cylindrical outer surface with a helical groove formed therein and a line attached to the spool and configured to be wound around the spool in the helical groove. The winch also includes a motor configured to rotate the spool in a first direction to wind the line onto the spool in the helical groove and a second direction to unwind the line off of the spool. The helical groove includes a line cradle shaped to carry the line with at least a portion of the line protruding out of the helical groove, and a channel in the helical groove extending below the line cradle. When the line is in the line cradle at least a portion of the channel is not occupied by the line. The winch also includes a line guide adjacent to the spool and configured to move axially along the spool to facilitate winding and unwinding the line onto the spool in the helical groove and off of the spool, the line guide comprising a tab that engages the channel to thereby cause the line guide to move axially along the spool to facilitate winding or unwinding the line, depending on the direction the spool is rotated.

Other embodiments of the present disclosure are directed to a winch including a motor, and a spool having a generally cylindrical body with a helical groove formed in an external surface of the spool that is rotatable by the motor. The winch also includes a line in the helical groove and being configured to wind onto and off of the spool in the helical groove when the motor rotates the spool. The winch also includes a line guide encircling the spool and having a slot through which the line passes as the line is wound onto and off of the spool. The line guide is configured to move axially along the spool as the line is wound onto and off of the spool.

Still other embodiments of the present disclosure are directed to a winch including a spool having a helical path formed therein and configured to receive a line wound around the spool in the helical path, the spool being rotatable by a motor to wind and unwind the line from the spool. The winch also includes a line guide with a main body having a generally cylindrical shape encircling the spool, a ridged head protruding inwardly from the main body, and a slot receiving the line to guide the line relative to the helical path as the line is wound onto and off of the spool. The helical path includes a line cradle having a generally rounded profile adapted to receive the line, and a channel extending below the line cradle, wherein the ridged head of the line guide is positioned in the channel, and whereby the channel causes the line guide to move axially along the spool as the spool rotates.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a side view of a spool for a winch according to embodiments of the present disclosure.

FIG. 2 is a cross-sectional view of the spool according to embodiments of the present disclosure.

FIG. 3 is an enlarged view of the helical groove according to embodiments of the present disclosure.

FIG. 4 is a cross-sectional view of a line guide according to embodiments of the present disclosure.

FIG. 5 is a cross-sectional view of a line guide according to other embodiments of the present disclosure.

FIG. 6 is a cross-sectional view of a line guide according to further embodiments of the present disclosure.

FIG. 7 is a cross-sectional view of a line guide in which the line guide engages the line cradle and/or channel directly according to embodiments of the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “winch” refers to lifting or pulling device consisting of a line winding around a horizontal rotating drum, turned by a crank or by motor or other power source.

As used herein, “winch,” “hoist,” “lift,” “winching device,” “hoisting device,” and “lifting device” are meant to refer to an apparatus that can be actuated to selectively raise and lower an object. These terms are generally interchangeable except for where specifically noted herein.

“Spool” is meant to refer to a generally cylindrical member that rotates to wind a line thereon.

“Line” is meant to refer to a cable, cord, wire, or other suitable interchangeable generally elongated, flexible, member that winds onto the spool.

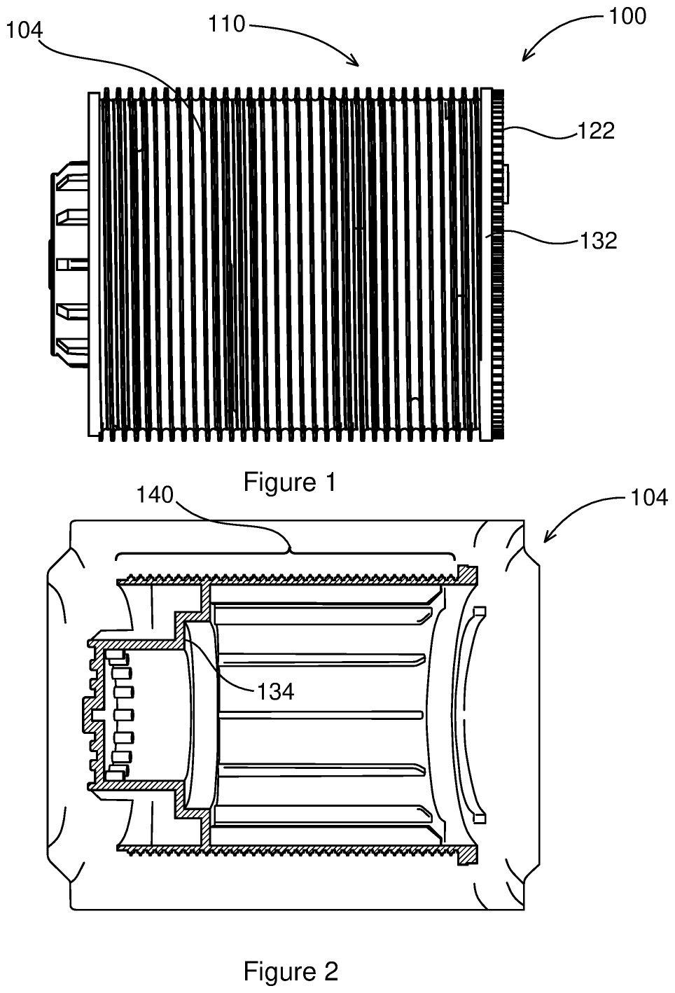

FIG. 1 is a side view of a spool 104 for a winch according to embodiments of the present disclosure. The first gear 122 is shown on the right-hand side of the spool 104. The spool 104 has a ring 132 at the right-hand side that has an outer diameter that is approximately equal to the outer diameter of the largest outer diameter of the first gear 122. The ring 132 helps to guide the first and second gears and to prevent the cable 110 from interfering with the gears.

FIG. 2 is a cross-sectional view of the spool 104 according to embodiments of the present disclosure. The spool 104 has an inner member 134 that facilitates connection to the motor that is found inside the spool 104 but is not pictured here. The inner member 134 also helps with structural strength for the spool 104. The spool 104 has a helical groove 140 on an outer surface of the spool 104 that extends around the spool 104 along substantially the axial length of the spool 104. The groove 140 receives the line as the spool 104 rotates to take up the line 110.

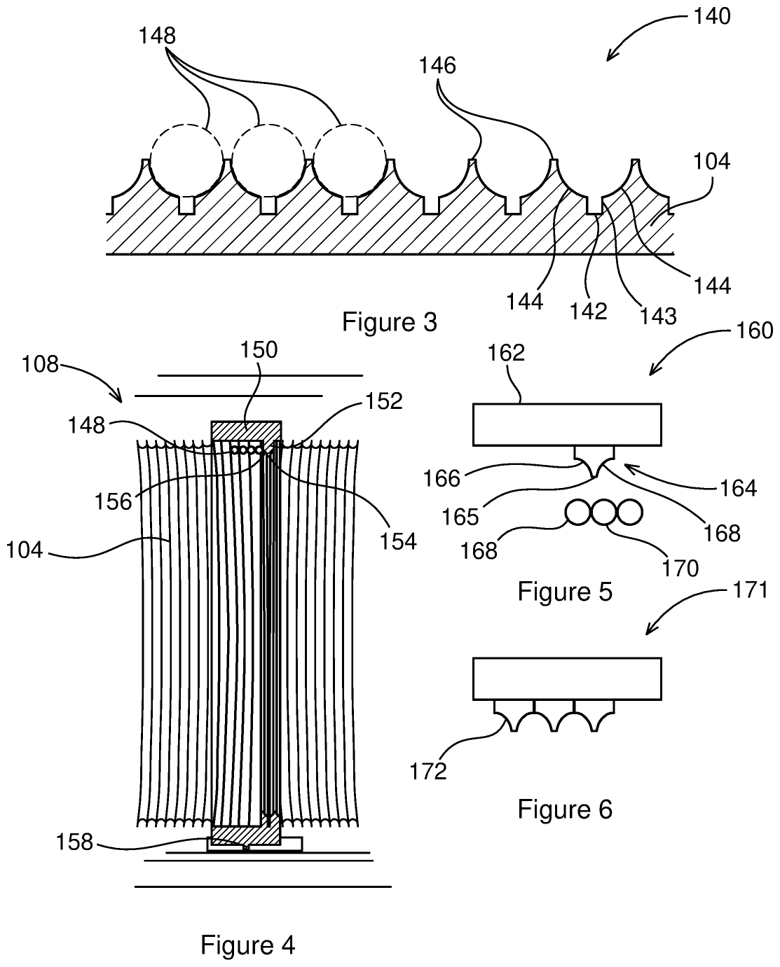

FIG. 3 is an enlarged view of the helical groove 140 according to embodiments of the present disclosure. The profile of the helical groove 140 is generally consistent along the helical path of around the spool 104. The shape of the helical groove 140 is a dual profile having two components: a line cradle 144 and a channel 142. The line cradle 144 is a rounded portion generally matching the shape of the line that will be carried in the helical groove 140. The channel 142 extends below the line cradle 144. A dashed line depicts a cross-section of a line 148 as it would sit when wound onto the spool 104. In some embodiments the height of the line cradle 144 is approximately half the diameter of the line 148. In other words, half of the line protrudes above the cradle. In other embodiments, the height of the line cradle is two-thirds the diameter of the line. In yet other embodiments the height of the line cradle is between 40% and 75% the diameter of the line. The shape of the line cradle 144 permits the pitch of the line 148 as it winds onto the spool 104 in the groove 140 to be finer than some prior art designs. Some prior art designs have included a deep groove that is as high or higher than the diameter of the line, resulting in the line sitting entirely below the furthest extent of the deep groove. The present design allows for more line to be wound on the same length of spool 104. The channel 142 is found in each coil of the groove 140 at the lowest extent of the groove 140. In some embodiments it has a square bottom profile. In some embodiments the channel 142 also includes a wall 143 that is generally perpendicular to the axis of the spool 104. In some embodiments the channel 142 is centrally located at a lowest extent of the line cradle 144. In other embodiments the channel 142 can be offset from the line cradle 144 and is not necessarily deeper than the line cradle 144.

FIG. 4 is a cross-sectional view of a line guide 108 according to embodiments of the present disclosure. The line guide 108 encircles the spool 104 at least partially around the circumference of the spool 104. The line guide 108 includes a main body 150 having a generally cylindrical profile. In some embodiments the line guide 108 does not encircle the entire circumference of the spool 104. The main body 150 has an inner diameter sized to permit the line to wind onto the spool 104 between the main body 150 and the spool 104. Not pictured here is the slot 114 shown in FIG. 2 through which the line passes as the line winds onto and off of the spool 104.

The line guide 108 also includes a protrusion 152 having a tab 154 that engages the channel 142 between coils of the groove 140, and shoulders 156 that engage the line cradle 144. A line 148 is shown in the groove 140 between the line guide 108 and the spool 104. The protrusion 152 can be ahead or behind the line 148 as the line winds onto and off of the spool 104. Accordingly, the line guide 108 follows the line 148 along the spool 104 as the line 148 winds around the spool 104. In some embodiments the tab 154 and guide trough are omitted in favor of using the concave portion 144 and shoulders 152. The line guide 108 also includes a key 158 on an outer diameter of the line guide 108 to ensure the line guide 108 does not rotate around the spool 104 but rather moves axially as the spool rotates.

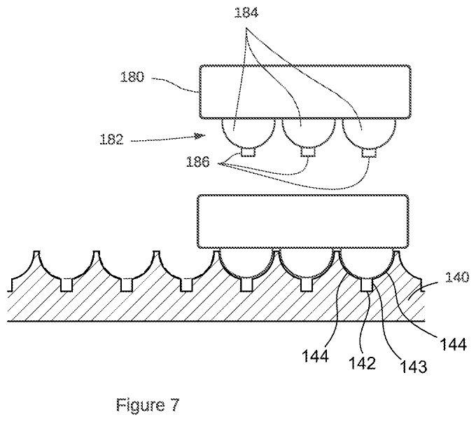

FIG. 5 is a cross-sectional view of a line guide 160 according to other embodiments of the present disclosure. In this embodiment, the line guide includes a wound line engaging portion, which wound line engaging portion is shaped to receive a protruding portion of wound line lying in the helical groove. As a result, the line guide is moved axially along the spool to wind the line when the spool is rotated in the one direction and to unwind the line when the spool is rotated in the other direction. As shown in FIG. 7, the line guide 160 in this embodiment includes a main body 162 and a ridged head 164. The ridged head 164 has ridge 165, a first concave surface 166 configured to contact a first coil of the line 166, and a second concave surface 168 configured to contact a second coil of the line 170. The ridged head 164 uses the coils of the line to move the line guide 160 axially along the spool. In this embodiment the channel of the embodiments shown in FIG. 5 are not needed and the line guide 160 uses the shape of the coils instead. Alternatively, the concave surfaces does not have a continuous radius of curvature, and instead may be have a faceted shape. In some embodiments the ridged head 164 has sufficient strength and engagement with the coils of the line that the line guide 160 is able to follow the position of the line as it winds onto and off of the spool.

FIG. 6 is a cross-sectional view of a line guide 171 according to further embodiments of the present disclosure. The line guide 171 includes a coil-engaging member 172 comprising three ridged heads generally similar to the ridged head of FIG. 7. In some embodiments there are two, three, four, or any suitable number of ridges in the coil-engaging member 172. The three-headed coil-engaging member 172 can engage four coils of the line. In these embodiments with no channel, less of the spool is used for the line guide, resulting in more line that can be wound onto the spool, and/or the spool may be narrower.

FIG. 7 is a cross-sectional view of a line guide 180 in which the line guide 180 engages the line cradle and/or channel directly according to embodiments of the present disclosure. Two depictions of the line guide 180 are represented here for purposes of clarity to show the line guide 180 itself, and to show the line guide 180 with protrusions in place relative to the spool 140. The line cradle 144, channel 142, and wall 143 are similar to elements shown in FIGS. 5 and 6. The line guide 180 includes protrusions 182 having a hemispherical portion 184 and a head 186. The hemispherical portion 184 is shaped and positioned to engage the line cradle 144. The rotation of the spool 140 causes the line guide 180 to move axially along with a point at which the line unwinds from the spool 140 and winds back onto the spool 140, depending on which direction the spool 140 is rotating at a given time. There may be one, two, or any suitable number of protrusions 182.

It is noted that, although much of the discussion above has involved lifting objects with the winches described, the disclosed winches can also be used for pulling objects. The tensioning wheel, that assures that the line is pulled off the spool as it is being unwound, is particularly advantageous to these pulling embodiments, that do not have gravity to assist pulling the line off the spool.

The tensioning wheel of the present disclosure contacts an exposed surface of the line as it winds onto the spool and moves at a speed based on the rotational speed of the spool. The radius is measured from the center of rotation of the spool, to the exposed surface of the line. This speed is referred to herein as the “line speed” or “linear speed of the line.” The speed may also be referred to as the tangential speed. The tensioning wheel has a contact surface that contacts the line. The tensioning wheel rotates at a certain rotational rate which can be manipulated as needed. The speed of the contact surface of the tensioning wheel is referred to herein as the “tensioning wheel speed.”

The gears of the winch and the tensioning wheel itself are constructed such that the tensioning wheel speed is between 1% and 50% faster than the line speed. The dimensions of the spool, line, and tensioning wheel may vary. Accordingly, the tensioning wheel frictionally slips along the line slightly to ensure there is tension on the line as it pays out. That is, the wheel drags along the line using the friction between the two to create the tension. If the speeds were identical there would be no frictional slip and the movement would be one-to-one. With a speed differential the wheel “slips” or “drags” along the line, thereby creating the desired tension. As the line is wound onto the spool, the one-way bearing allows the tensioning wheel to spin freely, whether or not it contacts the line.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A winch, comprising:
a spool having an axis of rotation and a cylindrical outer surface with a helical groove formed therein;
a line attached to the spool and configured to be wound around the spool in the helical groove;
a motor configured to rotate the spool in a first direction to wind the line onto the spool in the helical groove and a second direction to unwind the line off of the spool;
wherein the helical groove comprises:
a line cradle shaped to carry the line with at least a portion of the line protruding out of the helical groove; and
a channel in the helical groove extending below the line cradle, wherein, when the line is in the line cradle, at least a portion of the channel is not occupied by the line; and
a line guide adjacent to the spool and configured to move axially along the spool to facilitate winding and unwinding the line onto the spool in the helical groove and off of the spool, the line guide comprising a tab that engages the channel to thereby cause the line guide to move axially along the spool to facilitate winding or unwinding the line, depending on the direction the spool is rotated.

2. The winch of claim 1, wherein the portion of the line protruding out of the helical groove is at least one third of the line.

3. The winch of claim 1, wherein the portion of the line protruding out of the helical groove is at least one half of the line.

4. The winch of claim 1, wherein adjacent coils of the line when wound in the helical groove are separated by less than 10% of the diameter of the line.

5. The winch of claim 1, wherein adjacent coils of the line when wound in the helical groove are separated by less than 5% of the diameter of the line.

6. The winch of claim 1, wherein adjacent coils of the line when wound in the helical groove are touching.

7. The winch of claim 1, wherein the channel has a rectangular cross section and wherein the tab has a complimentary cross section.

8. The winch of claim 1, wherein the tab is shaped to compliment the cross section of the cradle and the cross section of the channel of the helical groove.

9. The winch of claim 1, wherein the line guide comprises a tensioning wheel configured to frictionally engage the line to thereby apply tension to the line as it unwinds, and wherein the motor drives the tensioning wheel.

10. The winch of claim 9, wherein the tensioning wheel is driven by the motor so as to have a tangential speed at least 5% greater than the linear speed of the line it engages as the line is being unwound, and further comprising a one-way bearing between the tensioning wheel and the motor, whereby the tensioning wheel can be rotated by its engagement with the line as it is being wound.

11. The winch of claim 10, wherein the tension wheel is configured to press against the line at the point the line comes off the respective spool.

12. The winch of claim 11, further comprising a rail with an axis of rotation parallel to the axis of the driveshaft, and wherein the rail is rotated by the motor.

13. The winch of claim 13, further comprising a ring gear rotated with the spool and a cog on the rail that engages the ring gear, and wherein the size of the ring gear and the size of the cog are selected to cause the tangential speed of the tensioning wheels to be at least 5% greater than the linear speed of the line it engages as it is being unwound.

14. The winch of claim 14, wherein the one-way bearings is located between the rail and the tensioning wheel.

15. A winch, comprising:
a motor;
a spool having a generally cylindrical body with a helical groove formed in an external surface of the spool, the spool being rotatable by the motor;
a line in the helical groove and being configured to wind onto and off of the spool in the helical groove when the motor rotates the spool; and
a line guide encircling the spool and having a slot through which the line passes as the line is wound onto and off of the spool, wherein the line guide is configured to move axially along the spool as the line is wound onto and off of the spool.

16. The winch of claim 15 wherein the helical groove is shallower than the line is thick, such that the line protrudes partially out of the helical groove, and wherein the line guide includes a ridged head that contacts a portion of the line when the line is in the helical groove, and wherein the ridged head causes the line guide to move axially relative to the spool.

17. A winch, comprising:
a spool having a helical path formed therein and configured to receive a line wound around the spool in the helical path, the spool being rotatable by a motor to wind and unwind the line from the spool; and
a line guide having:
a main body having a generally cylindrical shape encircling the spool;
a ridged head protruding inwardly from the main body; and
a slot receiving the line to guide the line relative to the helical path as the line is wound onto and off of the spool;
wherein the helical path includes a line cradle having a generally rounded profile adapted to receive the line, and a channel extending below the line cradle, wherein the ridged head of the line guide is positioned in the channel, and whereby the channel causes the line guide to move axially along the spool as the spool rotates.

18. The winch of claim 17 the line guide further comprising a tensioning wheel positioned relative to the slot such that the tensioning wheel contacts the line and exerts a tension onto the line as the spool rotates.

19. The winch of claim 18 wherein the tensioning wheel is rotated by the motor in an opposite direction from the spool.

20. The winch of claim 17 wherein the ridged head is positioned axially on a side of the spool opposite a connection point of the line and spool.
